(19) United States
(12) Patent Application Publication
(10) Pub. No.: US 2008/0111831 A1
(43) Pub. Date: May 15, 2008

(54) Efficient Panoramic Image Generation

(76) Inventors: Jay Son, Santa Clara, CA (US); Wei Yan, College Station, TX (US)

Correspondence Address: JAMES D IVEY;Tribute Tower, 409 13th Street, 11th Floor, OAKLAND, CA, 94612-2607, US

(21) Appl. No.: 11/560,334

(22) Filed: Nov. 15, 2006

(51) Int. Cl. G09G 5/00

(52) U.S. Cl. 345/629; 382/276; 382/284

(57) ABSTRACT

Steps in producing and publishing a panoramic image from component images are automated such that a user can simply click a single button to stitch and publish a panoramic image. The stitched panoramic image is automatically cropped, compression quality is automatically adjusted according to the quality of the stitched panoramic image, a thumbnail image of the stitched panoramic image is automatically generated, and wrapping of the stitched panoramic image is automatically detected—all without user intervention. The resulting panoramic image is completely viewable without further intervention by the authoring user.

### FIELD OF THE INVENTION

This invention relates to the field of computer-implemented graphics processing and, more specifically, to a particularly efficient mechanism for generating a panoramic image from a number of images.

### BACKGROUND

One commonly used system for generating panoramic images involves shooting sequential images with a camera on a tripod in a circular fashion, such that each image overlaps with the next. Collectively, the images cover views representing all 360 degrees around a space. To produce the panoramic image from these component images, stitching processing is applied to the component images to create a single panorama image. This approach requires purchasing and installing a software application. Panorama stitching programs are designed so that the user can load a set of individual, sequentially shot photographic image frames which are then assembled by the software program (installed on the pier computer), to create a stitched panorama image.

The user must then perform a series of actions or steps to the stitched panorama image to properly prepare the panoramic image for publishing and/or upload for dynamic display on the Internet. These programs are created and sold by such companies as Visual Tour, Tour Factory, EGG Solutions, RealVizStitcher, Easy Pano, iPix, Roxio (MGI software), etc. All of these programs require users to take a series of steps to properly create and prepare the panorama image and associated files for publishing online. Once these steps have been applied by the user and associated data files are created, these files can be uploaded to the web server for display in a dynamic, interactive manner through a wide area network such as the Internet.

The steps that must be performed by the user to properly prepare a panoramic image for publication impede use of panoramic stitching by casual users and limit production of panoramic images generally.

What is needed is a way to automate one or more of the steps currently performed under manual control by the user to better facilitate creation of panoramic images.

### SUMMARY OF THE INVENTION

In accordance with the present invention, a stitched panoramic image is processed automatically, i.e., without human user intervention, to produce a polished and viewable panoramic image. As a result, the casual, inexperienced user is capable of producing a nicely stitched, cropped, and compressed panoramic image with a representative thumbnail image from a number of component images very easily. In addition, anyone producing and publishing many stitched panoramic images can do so much more efficiently since many typically manual steps are automated.

The panoramic image is automatically cropped by excluding margins along one direction (e.g., vertically or horizontally) and finding the furthest outer limits along that direction that excludes all empty pixels. An empty pixel is a pixel that does not include any portion of any component images of which the stitched image is composed. For example, an empty pixel can be a pixel of a predetermined background color, e.g., perfectly black.

Within those outer limits, pixels are examined in a second direction to find the furthest outer limits along the second direction that excludes all empty pixels. The first and second outer limits define a crop region to which the stitched panoramic image can be cropped.

The process is repeated with the directions reversed, e.g., finding outer limits along the second direction first, then finding outer limits along the first direction, to produce a second crop region. The stitched panoramic image is cropped to the larger of the first and second crop regions.

Compression is automatically adjusted according to the quality of the stitched panoramic image. A current image quality of the stitched panoramic image is determined in terms of a quality setting for JPEG image compression. A predetermined desired image quality, e.g., an 80 quality setting for JPEG image compression, is compared to the determined quality of the stitched panoramic image. The stitched panoramic image is compressed using JPEG compression only if the quality of the stitched panoramic image is greater than the predetermined desired image quality. For example, if the quality of the stitched panoramic image is determined to be 65, compressing the stitched panoramic image with a quality setting of 80 would introduce additional noise into an already heavily compressed image. If the quality of the stitched panoramic image is determined to be 90, compressing the stitched panoramic image with a quality setting of 80 provides an acceptable compromise between image file size and image quality but consumes fewer resources than the stitched panoramic image would consume if compressed with a quality setting of 90.

A thumbnail image representative of the stitched panoramic image is automatically selected by selecting the largest area about the center of the stitched panoramic image of a predetermined aspect ratio. That area is represented in a thumbnail image of predetermined thumbnail image dimensions.

Wrapping of the stitched panoramic image is automatically detected by determining whether the lateral ends of the stitched panoramic image can be stitched together.

The stitched panoramic image, as cropped and compressed, is uploaded to a server for publication along with the thumbnail image and data indicating whether the stitched panoramic image wraps. Thus, nearly all preprocessing of the stitched panoramic image is fully automated.

### BRIEF DESCRIPTION OF THE DRAWINGS

FIG. 1 is a diagram showing a network in which a stitched panoramic image is preprocessed and published in accordance with the present invention.

FIG. 2 is a block diagram showing panoramic image generation logic in accordance with the present invention.

FIG. 3 is a screen view of the user interface by which the user selects component images for stitching and initiates automatic preprocessing of the stitched panoramic image in accordance with the present invention.

FIG. 4 shows component images to be stitched and preprocessed in an illustrative example.

FIG. 5 is a logic flow diagram of automated preprocessing in accordance with the present invention.

FIG. 6 shows a stitched panoramic image prior to automatic cropping in accordance with the present invention.

FIG. 7 is a logic flow diagram illustrating automatic cropping in accordance with the present invention.

FIGS. 8-12 illustrate various stages of automatic cropping in accordance with the present invention.

FIG. 13 is a logic flow diagram illustrating automatic compression in accordance with the present invention.

FIG. 14 is a logic flow diagram illustrating automatic thumbnail image generation in accordance with the present invention.

FIG. 15 illustrates thumbnail image selection from a panoramic image in accordance with the present invention.

### DETAILED DESCRIPTION

In accordance with the present invention, steps in producing and publishing a panoramic image from component images are automated such that a user can simply click a single button to stitch and publish a panoramic image. The resulting panoramic image is completely viewable without further intervention by the authoring user. As a result, panoramic images can be easily and readily composed and published by casual users and can be composed and published in significant quantities due to fewer demands on the authoring user.

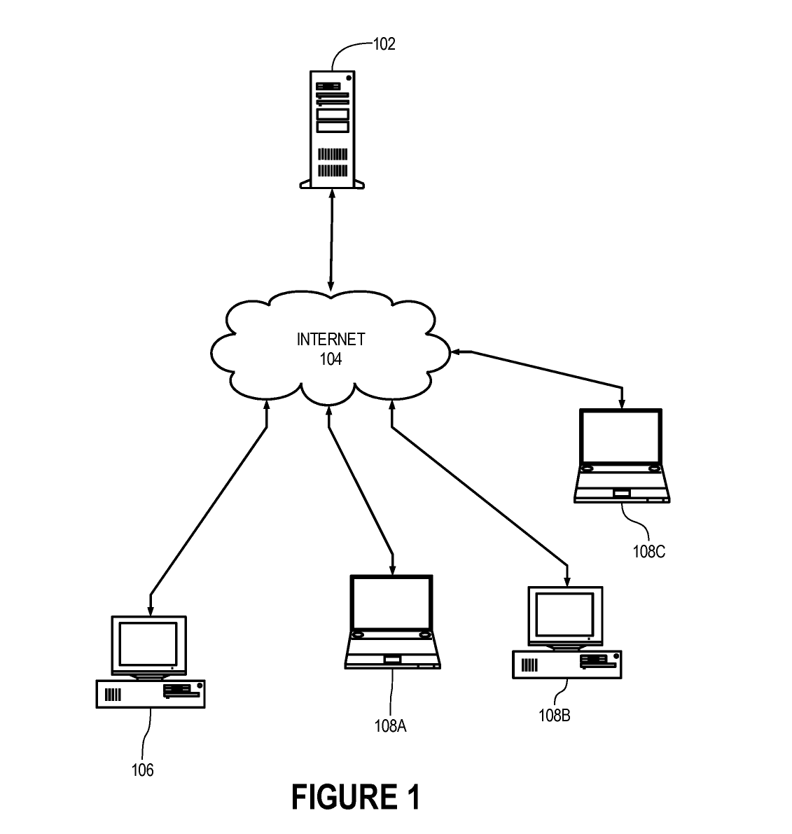

To facilitate appreciation and understanding of the present invention, the operational context of an illustrative embodiment is described in conjunction with FIG. 1. In this illustrative embodiment, a server 102 hosts one or more panoramic images for viewing through client computers 108A-C through a wide area network such as the Internet 104 for example. Author computer 106 is used by an authoring user to compose and publish a panoramic image through Internet 104. In this embodiment, a panoramic image is published by uploading the panoramic image to server 102 such that server 102 can send the panoramic image for viewing in one or more of client computers 108A-C.

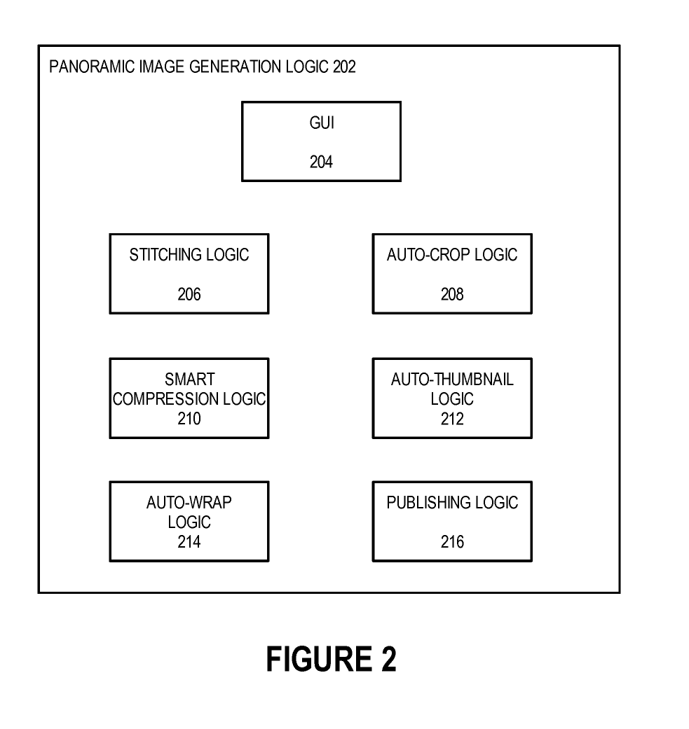

Composition and publication of panoramic images by author computer 106 is performed by panoramic image generation logic 202 (FIG. 2). Panoramic image generation logic 202 can be implemented within server 102 or within author computer 106 or within a combination of both. In this illustrative embodiment, panoramic image generation logic 202 includes computer instructions and/or data defining the behavior described herein in a downloadable form such as ActiveX or Java™. Thus, panoramic image generation logic 202 is defined within server 102 but executes as all or part of one or more processes within author computer 106.

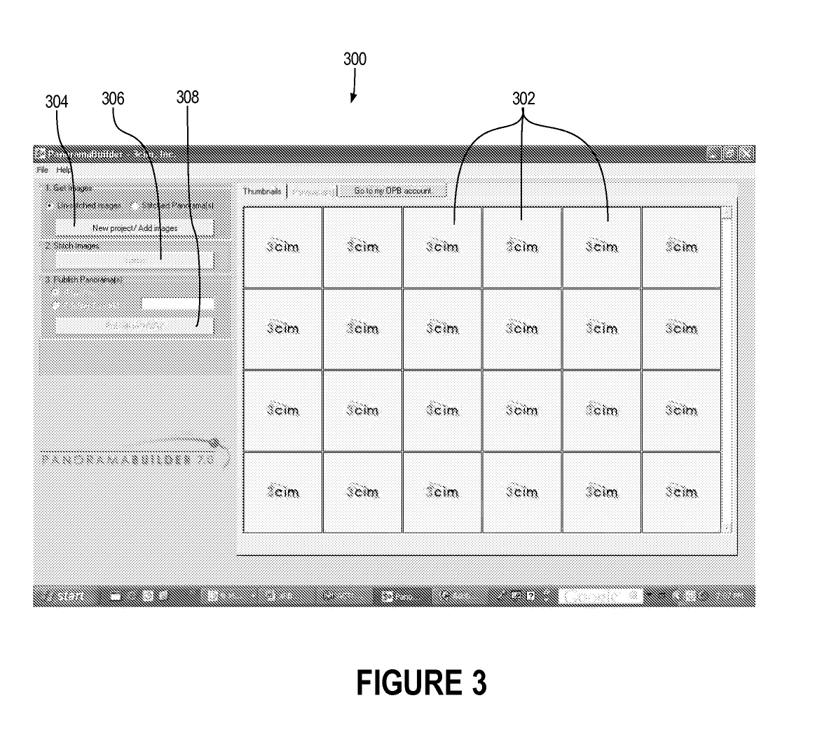

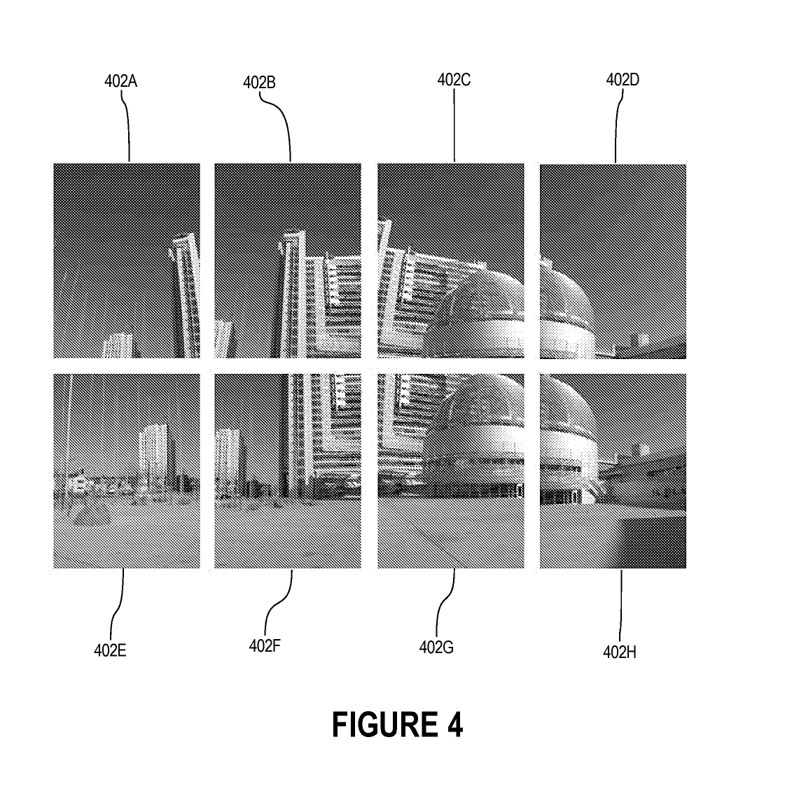

Panoramic image generation logic 202 includes a graphical user interface (GUI) 204 that interacts with the authoring user by presenting graphical and/or textual prompts through one or more computer output device and receiving signals generated by the authoring user through physical manipulation of one or more computer input devices. Screen view 300 (FIG. 3) is an illustrative example of a graphical user interface presented by GUI 204 to the authoring user on author computer 106. Screen view 300 includes a number of tiles 302 onto which the authoring user can drag and drop images to be stitched into a panoramic image. The authoring user drags and drops component images onto tiles 302. An illustrative example of component images in a tiled juxtaposition is described below in conjunction with FIG. 4.

Screen view 300 (FIG. 3) includes a button 304 by which the authoring user can cause panoramic image generation logic 202 to accept component images and information regarding relative positioning of each component image. A button 306 allows the authoring user to initiate stitching of the component images into a panoramic image by stitching logic 206. Stitching by stitching logic 206 is conventional and known and is not described further herein. A button 308 allows the authoring user to initiate publication of the resulting panoramic image. A number of types of preprocessing, such as cropping, compression, thumbnail selection, and wrap detection, are performed automatically in the manner described more completely below. In an alternative embodiment, button 306 and button 308 are combined into a single button, pressing of which by the user—in a single user input gesture—can initiate both generation of the panoramic image from the component images and publication of the panoramic image, including all preprocessing. In addition, buttons 304, 306, and 308 can be represented by a single button such that stitching, preprocessing, and publication are all performed automatically upon indication by the authoring user that all component images have been indentified.

The authoring user associates a number of component images with respective ones of tiles 302 in positions according to the relative views of the component images. As an illustrative example, component images 402A-H (FIG. 4) are so placed. Each of component images 402A-H shares substantive content with each adjacent one of component images 402A-H. In other words, the substantive content of component images 402A-H overlap and overlapping portions are positioned adjacent to one another.

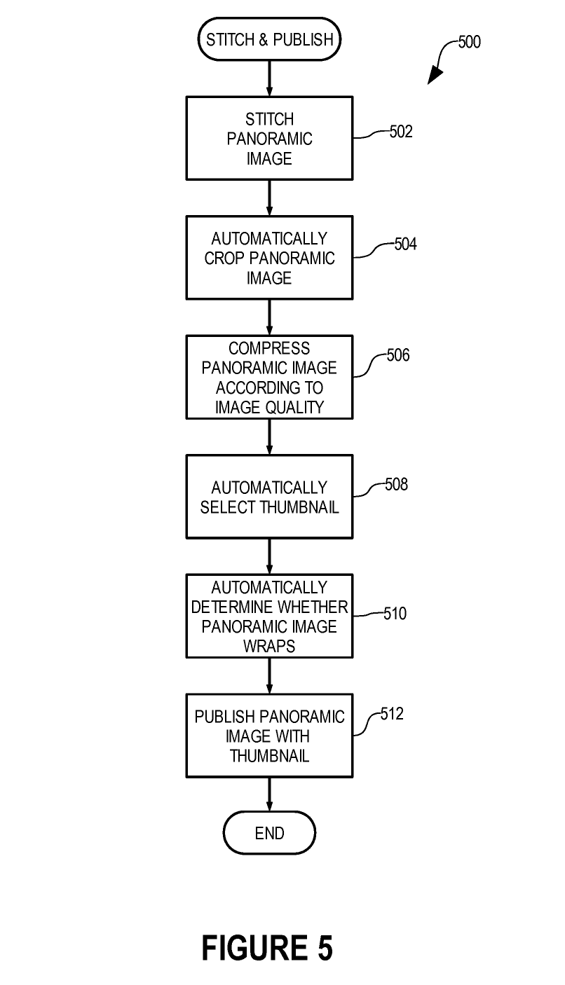

Stitching and publishing by panoramic image generation logic 202 is illustrated by logic flow diagram 500 (FIG. 5). In the embodiment shown in FIG. 3, step 502 (FIG. 5) is performed in response to actuation of button 306 (FIG. 3), and step 512 (FIG. 5) is performed in response to actuation of button 308—steps 504-510 can be performed in response to actuation of button 306 or in response to actuation of button 308. Alternatively, one or more of steps 504-510 can be performed in response to actuation of button 306 and the remainder of steps 504-510 can be performed in response to actuation of button 308. In the embodiment in which there is a single “Stitch & Publish” GUI button, all of steps 502-512 are performed in response to actuation of that single button.

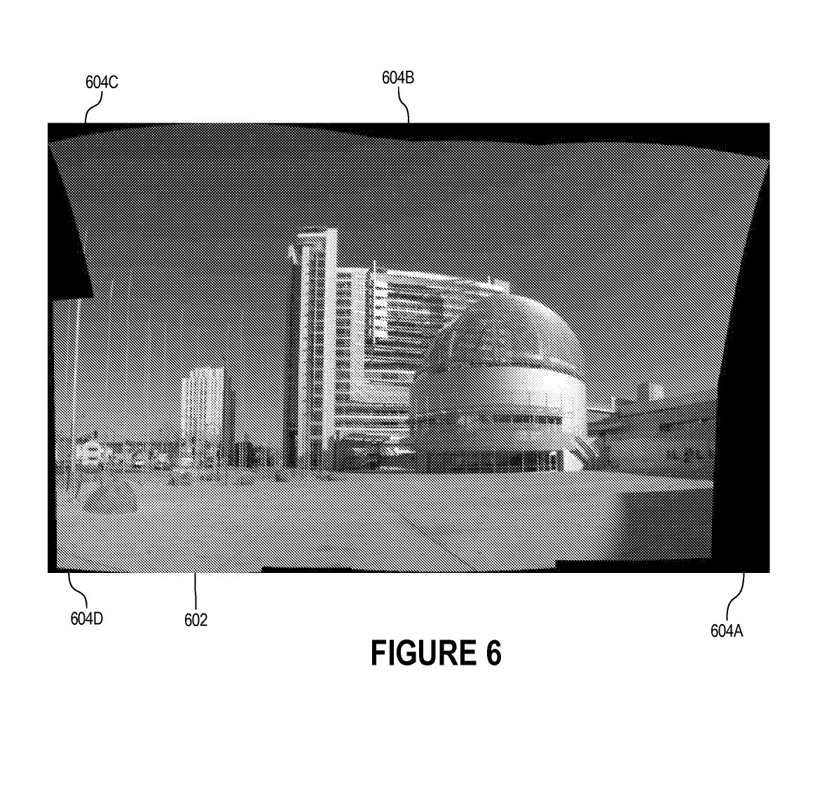

In step 502, stitching logic 206 (FIG. 2) stitches component images 402A-H (FIG. 4) to form a single stitched image 602 (FIG. 6). As can be seen in FIG. 6, stitched image 602 includes a number of dark border regions 604A-D in which no photographed image is represented. This is a common result of stitching component images in such a manner as to corrected for different perspectives in the respective component images. Ordinarily, the authoring user would manually indicate a largest rectangular area of stitched image 602 that does not include border regions 604A-D. However, in step 504 (FIG. 5), auto-crop logic 208 (FIG. 2) automatically selects such a region from stitched image 602 and crops stitched image 602 to that rectangular region.

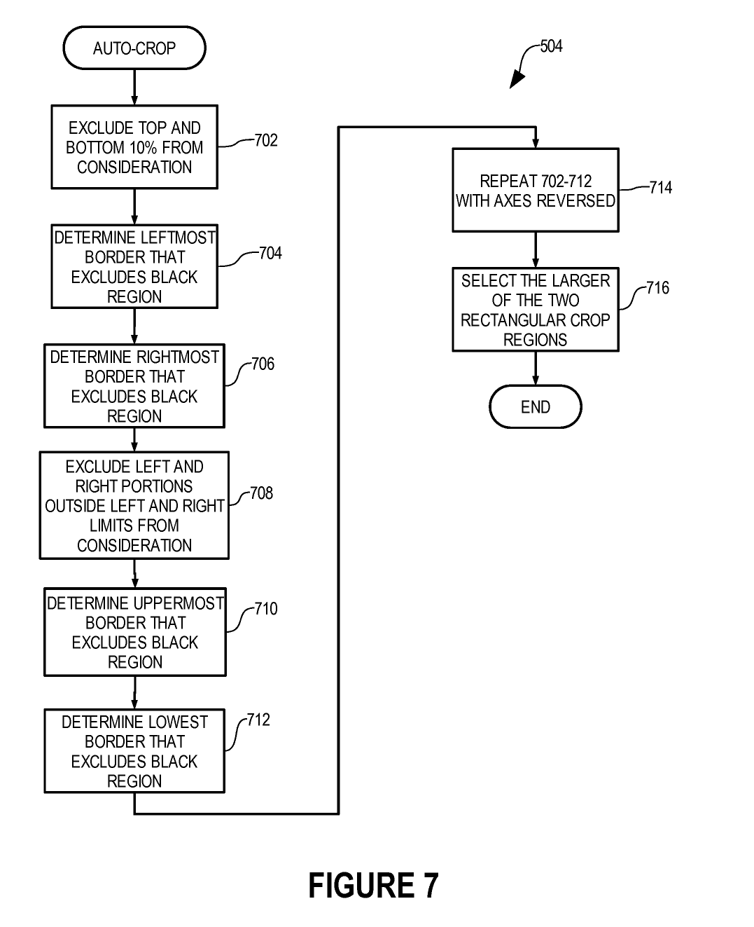

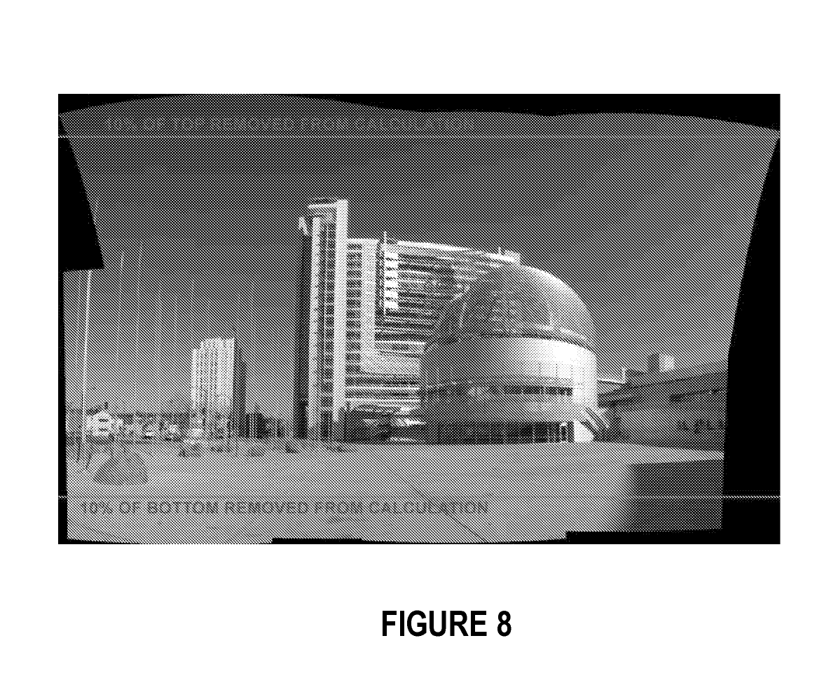

Step 504 is shown in greater detail as logic flow diagram 504 (FIG. 7). In step 702, auto-crop logic 208 excludes the top and bottom 10% of stitched image 602 from consideration, considering only the middle 80% of stitched image 602 in steps 704 and 706. The middle 80% under consideration is illustrated in FIG. 8.

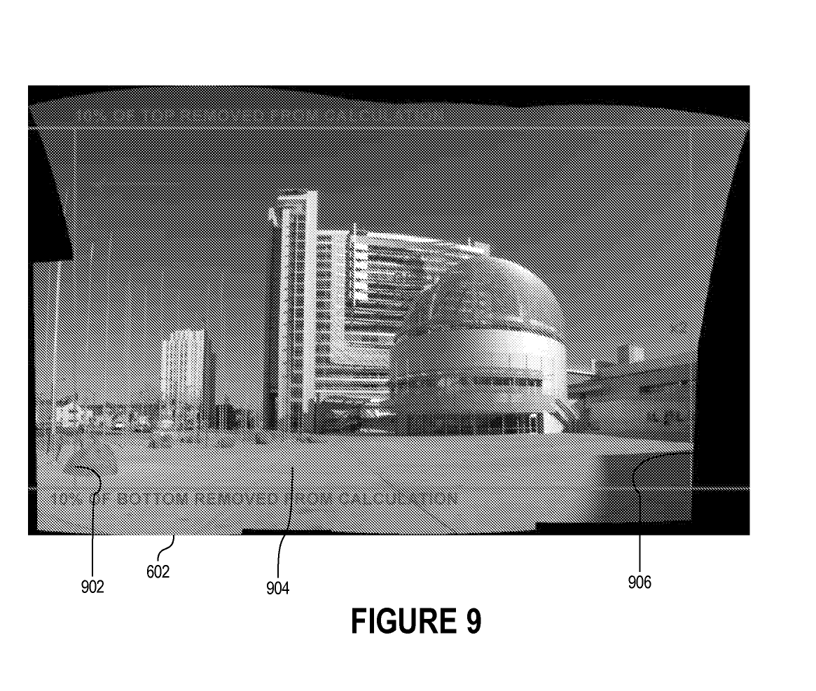

In step 704 (FIG. 7), auto-crop logic 208 (FIG. 2) determines a left boundary within the middle 80%, i.e., middle region 904 (FIG. 9). To determine the left boundary, auto-crop logic 208 starts at the center of stitched image 602 and searches leftward within the middle 80% for a leftmost vertical boundary that excludes border regions 604A-D. In this illustrative embodiment, auto-crop logic 208 determines that line 902 represents the leftmost vertical boundary that excludes border regions 604A-D within middle section 904 when a horizontal line of all background-colored pixels extends from line 902 to the left edge of stitched image 602 within the vertical boundaries of middle section 904.

In step 706 (FIG. 7), auto-crop logic 208 (FIG. 2) determines a right boundary within the middle 80%, i.e., middle region 904 (FIG. 9). To determine the right boundary, auto-crop logic 208 (FIG. 2) starts at the center of stitched image 602 and searches rightward within middle region 904 for a rightmost vertical boundary that excludes border regions 604A-D. In this illustrative embodiment, auto-crop logic 208 determines that line 906 represents the rightmost vertical boundary that excludes border regions 604A-D within middle section 904 when a horizontal line of all background-colored pixels extends from line 906 to the right edge of stitched image 602 within the vertical boundaries of middle section 904.

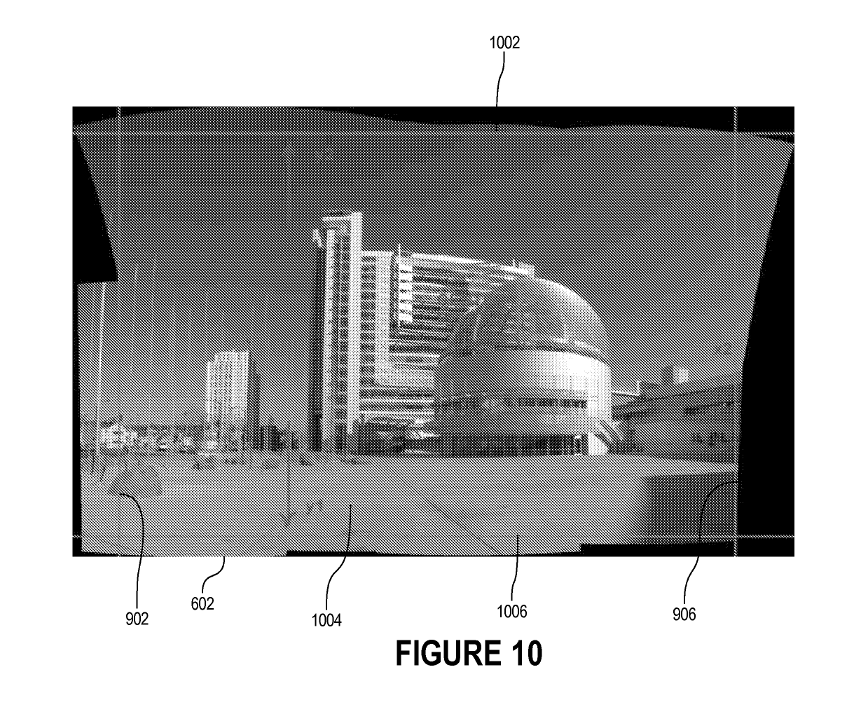

In step 708, auto-crop logic 208 excludes the portions of stitched image 602 outside the left and right boundaries determined in steps 704-706 from consideration, considering only middle region 1004 (FIG. 10) of stitched image 602 in steps 710 and 712.

In step 710 (FIG. 7), auto-crop logic 208 (FIG. 2) determines an upper boundary within middle region 1004 (FIG. 10) between left boundary 902 and right boundary 906. To determine the upper boundary, auto-crop logic 208 starts at the center of stitched image 602 and searches upward within middle region 1004 for a uppermost horizontal boundary that excludes border regions 604A-D. In this illustrative embodiment, auto-crop logic 208 determines that line 1002 represents the uppermost horizontal boundary that excludes border regions 604A-D within middle section 1004 when a vertical line of all background-colored pixels extends from line 1002 to the top edge of stitched image 602 within the horizontal boundaries of middle section 1004.

In step 712 (FIG. 7), auto-crop logic 208 (FIG. 2) determines a lower boundary within middle region 1004 (FIG. 10) between left boundary 902 and right boundary 906. To determine the lower boundary, auto-crop logic 208 (FIG. 2) starts at the center of stitched image 602 and searches downward within middle region 1004 for a lowest horizontal boundary that excludes border regions 604A-D. In this illustrative embodiment, auto-crop logic 208 determines that line 1006 represents the lowest horizontal boundary that excludes border regions 604A-D within middle section 1004 when a vertical line of all background-colored pixels extends from line 1006 to the bottom edge of stitched image 602 within the horizontal boundaries of middle section 1004.

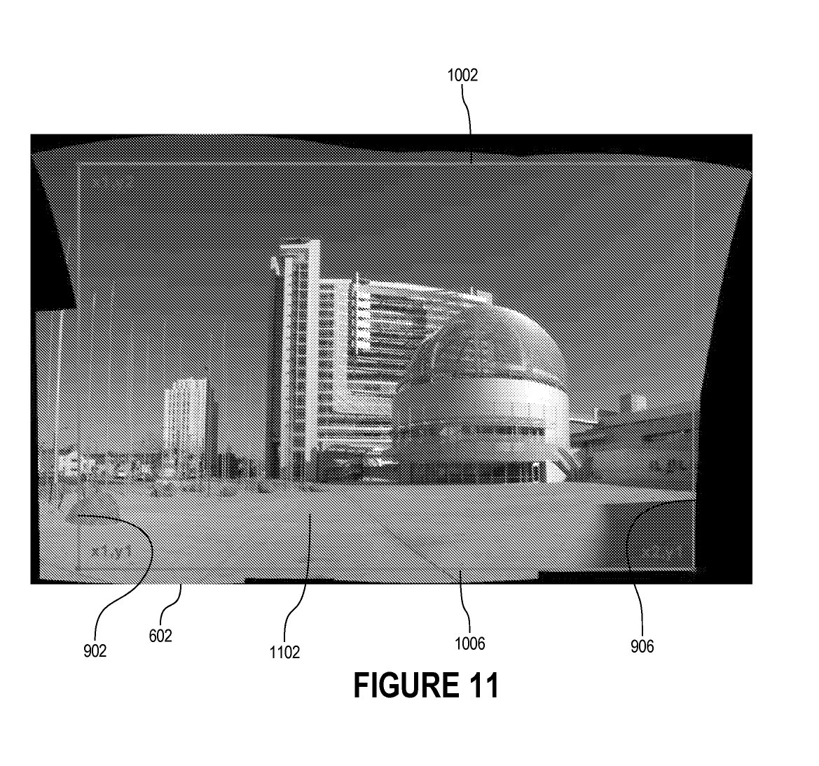

After processing according to steps 702-712, auto-crop logic 208 has identified a rectangular crop area 1102 (FIG. 11) defined by lines 902, 906, 1002, and 1006.

In step 714 (FIG. 7), auto-crop logic 208 repeats steps 702-712 with the axes reversed. In particular, auto-crop logic 208 first determines upper and lower boundaries in the general manner described above with respect to steps 702-706, e.g., excluding the leftmost 10% and the rightmost 10%, and then determines left and right boundaries in the general manner described above with respect to steps 708-712, e.g., excluding regions above and below the determined upper and lower borders, respectively. The result of step 714 is an alternative rectangular crop area.

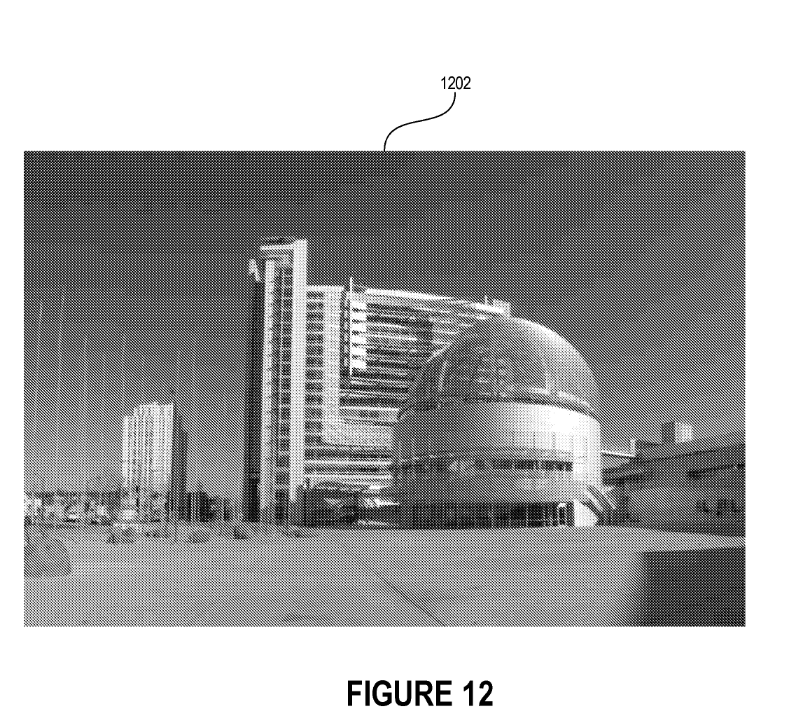

In step 716, auto-crop logic 208 selects the larger of the two rectangular crop areas and crops stitched image 602 to the selected crop area. The result is a properly cropped stitched image, e.g., panoramic image 1202 (FIG. 12), with the largest possible rectangular area that excludes all of border regions 604A-D (FIG. 6), all without intervention by the authoring user. As a result, cropping is fully automatic, facilitating easy creation of high-quality panoramic images by even a casual, unskilled user.

After step 716 (FIG. 7), processing according to logic flow diagram 504, and therefore step 504 (FIG. 5) completes.

In step 506, smart compression logic 210 (FIG. 2) compresses panoramic image 1202 according to the image quality of panoramic image 1202. Since panoramic image 1202 is constructed from component images 402A-H (FIG. 4) and component images 402A-H are provided by the authoring user, panoramic image 1202 is of unknown quality. A typical approach is to ignore the image quality and merely set a fixed image quality to a panoramic image, e.g., by encoding the panoramic image in the JPEG format with a predetermined, fixed image setting such as 80. However, if component images 402A-H are encoded with JPEG image quality settings significantly lower, e.g., 60, encoding panoramic image 1202 with a JPEG image quality setting of 80 is unnecessarily deferential to the image content of component images 402A-H at the expense of resources such as space to store panoramic image 1202 and bandwidth to deliver panoramic image 1202 through Internet 104. Accordingly, smart compression logic 210 compresses panoramic image 1202 according to the image quality of panoramic image 1202.

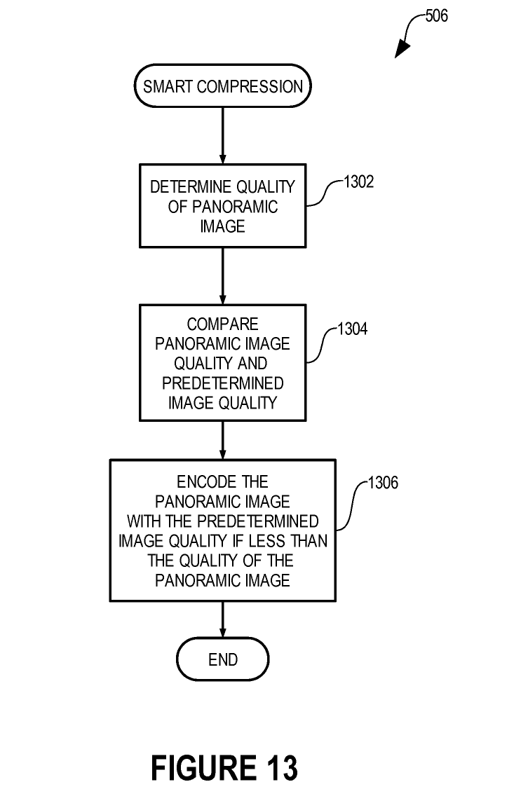

Step 506 is shown in greater detail as logic flow diagram 506 (FIG. 13). In step 1302, smart compression logic 210 (FIG. 2) determines a degree of image quality of panoramic image 1202. In this illustrative embodiment, smart compression logic 210 represents the determined image quality as an equivalent JPEG image quality. In particular, the image quality determined by smart compression logic 210 represents the JPEG image quality that, if used to compress an original into a JPEG image, would result in the quality of panoramic image 1202. For example, if smart compression logic 210 determines that panoramic image 1202 has an image quality of 70, smart compression logic 210 estimates that JPEG compression with an image quality of 70 would product an image with approximately the same amount of image noise as detected in panoramic image 1202.

Determination of a JPEG image quality of an image is known and not described further herein. In one embodiment, smart compression logic 210 reads a JPGQuality property of panoramic image 1202 using ImgX image processing software available from Altasoft, Inc.

In step 1304 (FIG. 13), smart compression logic 210 compares the image quality determined in step 1302 to a predetermined maximum image quality. In this illustrative embodiment, the predetermined maximum image quality is 80. It is believed that this image quality provides good compression ratios with no perceptible image degradation.

In step 1306, smart compression logic 210 encodes panoramic image 1202 into a JPEG format using the predetermined maximum image quality if the image quality determined in step 1302 is greater than the predetermined maximum image quality. As a result, panoramic images with relatively poor quality are not further compressed so as to avoid additional loss of image quality. In other words, a low image quality suggests that panoramic image 1202 is sufficient compressed already. Higher quality panoramic images are compressed at a level that produces little or no perceptible image quality loss.

After step 1306, processing according to logic flow diagram 506, and therefore step 506 (FIG. 5), completes.

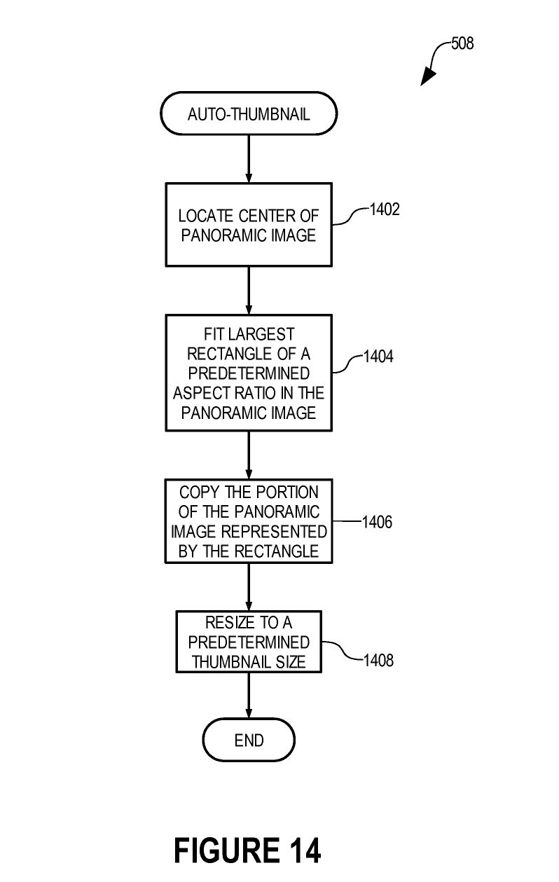

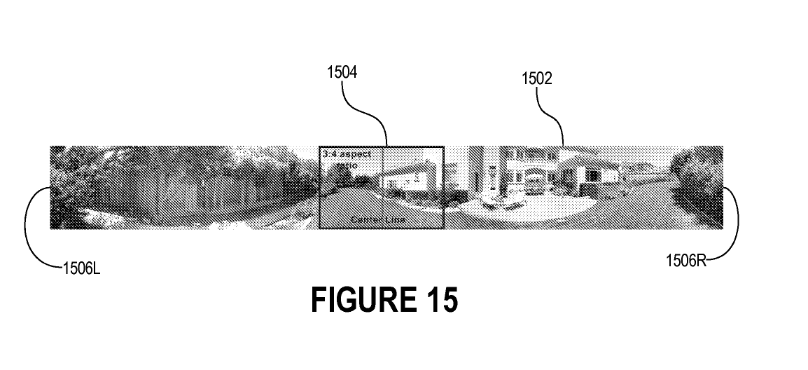

In step 508, auto-thumbnail logic 212 automatically generates a thumbnail image to represent panoramic image 1202. Step 508 is shown in greater detail as logic flow diagram 508 (FIG. 14) and is described in the illustrative context of panoramic image 1502 (FIG. 15). In step 1402 (FIG. 14), auto-thumbnail logic 212 locates the center of panoramic image 1502. In step 1404, auto-thumbnail logic 212 fits the largest rectangle within panoramic image 1502 that is both centered about the center of panoramic image 1502 and that has a predetermined aspect ratio. In this illustrative example, the predetermined aspect ratio is 3:4. The rectangle selected in step 1404 is shown as rectangle 1504 (FIG. 15).

In step 1406, auto-thumbnail logic 212 copies that portion of panoramic image 1502 that lies within rectangle 1504. In step 1408, auto-thumbnail logic 212 resizes the copied portion to a predetermined thumbnail image size, e.g., 160-by-120 pixels in this illustrative embodiment. Thus, auto-thumbnail logic 212 derives a small image representative of the overall content of panoramic image 1502 to display as a thumbnail image, clicking of which by any user of client computers 108A-C requests display of panoramic image 1502. After step 1408, processing according to logic flow diagram 508, and therefore step 508 (FIG. 5) completes.

In step 510, auto-wrap logic 214 determines whether panoramic image 1502 represents a full 360-degree view, i.e., whether panoramic image 1502 wraps. If panoramic image 1502 wraps, left edge 1506L and right edge 1506R should match such that edges 1506L and 1506R can be presented adjacent to one another to give the appearance of a seamless image. In the user's experience, panning panoramic image 1502 past left edge 1506L continues seamlessly with panoramic image 1502 starting with right edge 1506R. As examples, panoramic image 1502 wraps and panoramic image 1202 does not wrap.

To determine whether panoramic image 1502 wraps, auto-wrap logic 214 applies conventional stitching logic to ends 1506L and 1506R as if they were component images to be stitched to one another to determine whether ends 1506L and 1506R can be stitched. If so, auto-wrap logic 214 determines that panoramic image 1502 wraps. Otherwise, auto-wrap logic 214 determines that panoramic image 1502 does not wrap.

In step 512, publishing logic 216 publishes the panoramic image as processed in steps 502-510. To publish a panoramic image, the panoramic image is stored within server 102 in combination with a thumbnail image and information indicating whether then panoramic image wraps. At that point, the panoramic image is ready for presentation to any of client computers 108A-C through Internet 104.

Thus, by merely selecting a few component images such as component images 402A-H and clicking one or two buttons, any user can very easily and quickly publish presentation-quality panoramic images.

The above description is illustrative only and is not limiting. Instead, the present invention is defined solely by the claims which follow and their full range of equivalents.

What is claimed is:

1. A method for publishing a stitched panoramic image, the method comprising:
selecting a portion of the stitched panoramic image that excludes one or more border regions of the stitched panoramic image without user intervention;
cropping the stitched panoramic image to the portion without user intervention;
selecting a thumbnail portion of the stitched panoramic image without user intervention;
forming a thumbnail image from the thumbnail portion of the stitched panoramic image without user intervention; and
storing the stitched panoramic image as cropped and the thumbnail image in a server that makes the stitched panoramic image available for viewing.

2. The method of claim 1, further comprising:
detecting whether the stitched panoramic image wraps without user intervention;
further wherein storing includes storing data indicating whether the stitched panoramic image wraps in the server.

3. The method of claim 1, further comprising:
compressing the stitched panoramic without user intervention.

4. A method for cropping a stitched panoramic image without user intervention, the method comprising:
in a first middle portion of the stitched panoramic image along a first direction, finding first dimension limits that exclude empty pixels of the stitched panoramic image;
in a second middle portion of the stitched panoramic image along a second direction between the first dimension limits, finding second dimension limits that exclude empty pixels of the stitched panoramic image; and
cropping the stitched panoramic image to a region defined at least in part by the first and second dimension limits.

5. The method of claim 4 wherein the second direction is perpendicular to the first direction.

6. The method of claim 4 wherein the empty pixels are pixels of the stitched panoramic image having a background color.

7. The method of claim 6 wherein the background color is black.

8. The method of claim 4 wherein first direction limits are the furthest limits along the first direction that exclude empty pixels in the first middle portion; and
further wherein the second direction limits are the furthest limits along the second direction that exclude empty pixels in the second middle portion.

9. The method of claim 4 further comprising:
in a third middle portion of the stitched panoramic image along the second direction, finding third dimension limits that exclude empty pixels of the stitched panoramic image;
in a fourth middle portion of the stitched panoramic image along the first direction between the third dimension limits, finding fourth dimension limits that exclude empty pixels of the stitched panoramic image; and
wherein the cropping comprises cropping the stitched panoramic image to a larger one of a first region defined by the first and second dimension limits and a second region defined by the third and fourth dimension limits.

10. A method for compressing a digital image while preserving image quality, the method comprising:
determining a level of quality of the digital image;
comparing the level of quality to a predetermined desired level of quality; and
compressing the image to the predetermined desired level of quality upon a condition in which the level of quality is greater than the predetermined desired level of quality.

11. The method of claim 10 wherein the digital image is a stitched panoramic image.

12. The method of claim 10 wherein the level of quality is represented as a compression parameter.

13. A method for automatically selecting a thumbnail image representative of a larger panoramic image, the method comprising:
identifying a center of the panoramic image without human intervention;
selecting a portion of the panoramic image about the center, wherein the portion has a predetermined desired aspect ratio without human intervention; and
representing the portion in the thumbnail image without human intervention.

14. The method of claim 13 wherein the panoramic image is a stitched panoramic image.

15. The method of claim 13 further comprising:
forming the thumbnail image in a predetermined desired size without human intervention.

16. A method for presenting a panoramic image, the method comprising:
determining whether opposing lateral edges of the panoramic image can be stitched;
upon a condition in which the opposing lateral edges of the panoramic image can be stitched, presenting the panoramic in a manner that permits wrapping of the view of the panoramic image; and
upon a condition in which the opposing lateral edges of the panoramic image cannot be stitched, presenting the panoramic in a manner that does not permit wrapping of the view of the panoramic image.

17. The method of claim 16 wherein the panoramic image is a stitched panoramic image.

18. The method of claim 1 wherein each of the steps of selecting, cropping, selecting, and forming can be performed on a server computer or a client computer, wherein the server computer and client computer are connected to one another through a computer network.
